(19) United States
(12) Patent Application Publication
(10) Pub. No.: US 2017/0275181 A1
(43) Pub. Date: Sep. 28, 2017

(54) MOBILE WATER RECYCLING RECOVERY SYSTEM AND METHODS

(71) Applicant: Acme Concrete Paving, Inc., Spokane, WA (US)

(72) Inventor: Steven White, Valleyford, WA (US)

(73) Assignee: Acme Concrete Paving, Inc

(21) Appl. No.: 15/472,236

(22) Filed: Mar. 28, 2017

Related U.S. Application Data
(60) Provisional application No. 62/314,315, filed on Mar. 28, 2016.

(51) Int. Cl. C02F 1/00; B01D 25/12; B01D 36/02; B01D 33/03

(52) U.S. Cl. CPC C02F 1/004; B01D 33/03; B01D 25/12; B01D 36/02; C02F 2103/12

(57) ABSTRACT

This disclosure is directed to a mobile recovery system and methods. The system may receive a medium containing particles to be separated. The mobile system may include several modules that may remove various particles or substances from the medium and/or treat the medium to change a characteristic of the medium. The system may be located on a mobile platform. The system may be configure to perform the desired functions and methods either in a temporarily fixed location or while in motion.

### RELATED APPLICATION

This Application claims the benefit of U.S. Provisional Patent Application No. 62/314,315 entitled “Mobile Water Recycling Recovery System and Methods,” filed on Mar. 28, 2016, which is incorporated herein by reference.

### BACKGROUND

Water is often used in roadway construction, modification, or maintenance. Recovering, cleaning, and recycling the water efficiently and effectively has a great potential to benefit the industry and those affected by the end product. Current practices often require the containment, collection, and treatment of the waste water. The treatment usually occurs away from the construction activities requiring additional land for storage and processing of the waste water, as well as the transportation to and from the treatment site.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This disclosure describes, in part, a system and method for recovering water from construction operations. For example, water may be used in roadway construction, modification, or maintenance. Recovering, cleaning, and recycling the water efficiently and effectively has a great potential to benefit the industry and those affected by the end product.

For example, slurry water created from the construction operations may be pumped from the operation or device performing the operation. For example, the slurry water may be pumped from a grinding machine to a recycling trailer. The recycling trailer may contain several modules that may separate waste from the construction operations from the water on the recycling trailer. Various embodiments contemplate several modules separating various components from the slurry. Additionally or alternatively, the separated components may be stored on the recycling trailer or transferred to another vehicle or location. Additionally or alternatively, the water separated from the slurry may be stored on the recycling trailer or transferred to another vehicle or location.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIGS. 1A-B show an illustrative cutaway embodiment of a recovery system.

FIGS. 2A-C show an additional illustrative embodiment of the recovery system.

FIG. 3 shows an illustrative method of mobile separation utilizing the systems shown in FIGS. 1A-2C.

### DETAILED DESCRIPTION

### Overview

This disclosure describes, in part, a system and method for recovering water from construction operations. For example, water may be used in roadway construction, modification, or maintenance. Recovering, cleaning, and recycling the water efficiently and effectively has a great potential to benefit the industry and those affected by the end product.

In the concrete cutting, grinding and grooving industry the diamond blades must be cooled with water to prevent them from overheating and being damaged. When this is done, the cooling water combines with the concrete cutting particles to form slurry water. In this slurry water, depending on the application, there is a combination of suspended aggregate and cementitious material. Often, this slurry water is generally high on the pH scale. If desired or required by the user or governing body (this can be private, State, Federal, FAA, EPA or many others) this water must be captured and disposed of in a responsible manner. Many times this slurry water must be directed to a designated area, which often includes hauling off site to an approved location for processing. This processing can involve many different techniques. Some as basic as a simple pond with weirs to settle out the solids leaving a base material to dry out, a centrifuge, filter press, or plate press just to name a few. All of these methods require a stationary site that the slurry water must be hauled to. This process is labor and capital intensive. One must secure and maintain a site, procure (which often includes purchasing) the processing equipment and hauling trucks and trailers as well as the labor to staff/operate the same. It may also dictate that large quantities of High pH water must be hauled sometimes large distances. Water usage is often extremely high for this industry at a time when there are water shortages everywhere.

### Illustrative Embodiments of Recovery Systems

This recovery system and method may reduce or resolve many of the challenges this industry, among other industries, faces with respect to waste and overhead expenses including, but not limited to waste and waste water management, processing by-products, land requirements, environmental impact, and economic impacts to name a few.

The following is a brief overview of an illustrative embodiment. For example, the slurry water may be pumped from the operation or device performing the operation. For example, the slurry water may be pumped from a grinding machine to the recycling trailer via a diaphragm pump mounted on the grinder/groover generally. Various methods and devices may be used to deliver the slurry water to the recovery system without affecting the scope of this disclosure. For example, in some applications this material will have to be sucked up by the recovery system itself for it to get processed. Various embodiments contemplate recovery of slurry water from many operations. For illustrative purposes only, the following embodiments are focused on grinding and grooving applications. For example, the slurry water may enter the recovery system through a hose that may or may not be on a large retractable hose reel that may make hook ups quicker and easier.

Regardless of whether the slurry water was sucked or pumped into the recovery system, the slurry water may be under pressure and may be discharged in the recovery system onto a relatively rough separation stage. For example, the slurry water may be discharged on to a high “G” vibrating screen. Various embodiments contemplate that the vibrating screen may comprise a 50 mesh sized screen. Additionally or alternatively, the vibrating screen may comprise a screen at an inclined angle, for example, between zero to 25 degrees, or up to 45 degrees. Additionally or alternatively, the vibrating screen may operate between 1500 and 7200 cycles per minute. However, it is contemplated that this mesh size can be variable, as desired to assist the production of material being retained on the deck of the screen. This will also influence if not dictate the product (for example, the maximum size of the particles in the slurry water) that will be sent to the relatively finer separation stage, for example, a plate press. For example, the slurry water flows onto the top deck of a single deck screen. This screen will separate off any particles larger than the designated screen opening. For illustrative purposes a 50 mesh screen may be used. Any particles larger than 50 mesh will be caught on the deck and vibrated off the end to a collecting hopper or other disposal means. An illustrative embodiments contemplate a self-dumping hopper at the back of the recovery system trailer to facilitate easy disposal of the material at the end of a shift, operation, schedule, ad hoc basis, continuously, or combinations thereof. This hopper may comprise one or more hydraulic cylinders to actuate. Additionally or alternatively, the hydraulic cylinders may be powered by the hydraulic power pack that is also used with the plate press. In this embodiment, the dump style hopper may capture most or all of the separated material in smaller production operations such as sawing and light bump grinding. However, in larger production applications, such as large profile grinding it may be necessary to off load during the production shift. One of the various embodiments that may accomplish this may comprise a remote controlled swinging auger or conveyor out the rear of the recovery system trailer. Various embodiments contemplate that this offloading conveyor may be fed by another auger or conveyor at the bottom of the collection hopper. Additionally or alternatively, the offloading conveyor may be removed or may be stored along the back of the trailer for transportation.

Returning to the separation stages, various embodiments contemplate that after the +50 mesh material has been screened out of the slurry water, the remaining water which contains the suspended cementitious material falls through the screen to a holding or buffer tank. This holding tank may use agitation to help keep the material in suspension. From this tank, the slurry water may be moved to the relatively finer separation stage. For example, a diaphragm pump may pull the slurry water out of the tank and push it to the inlet of the plate press. In this illustrative embodiment, the relatively finer separation stage may comprise a plate press. For example, the plate press may be closed at this point and is pushing this water through the filter media around the plates. This is one of the illustrative ways that relatively clean water is produced from the slurry water. The clean water comes out through the fabric and is captured in an initial holding tank. The plates are held in position under pressure by a hydraulic cylinder. Once the plates fill up, the inlet pressure will rise until it reaches the user defined pressure set point. This set point will determine the dryness of the “cake” being made between the plates. Once the set point is reached the press will shut off the feed from the buffer tank, shut off the inlet valve and the press will the cycle open. No water flows through the press at this time. However, in various embodiments, the operation creating the slurry water, for example the grinding, may still continue. For example, the slurry water is going over the screen still and dumping into the holding tank. Once the press is open it may shake to free up any hanging “cakes”. The press may then close, open the inlet valve and turn the plate press slurry water pump back on. During this time, it may be desirable that the press is sized and configured to operate quickly enough to draw down the holding tank sufficiently to be ready for the next cleaning cycle. Often, in theory, the production of the grinders is never or rarely interrupted. Since the filter press is not configured to operate at one constant production rate, the average filter press throughput rate would exceed the water usage of the grinders themselves. For illustrative purposes, a 50 gallons per minute average slurry water throughput rate is contemplated. However, this through put can vary depending on production needs, operations contemplated, or other configurations. For example, various embodiments contemplate using more than one filtering technique or device in the relatively finer separation stage. For example, a plurality of plate presses may be used where the operation of the plurality of plate presses may be offset, run on an ad hoc timing, run where one or more is held in reserve until it is needed to keep the average throughput up (this may allow for a smaller sized unit or may help coordinate or control wear or maintenance on the unit). Additionally or alternatively, a plurality of filtering techniques may be used in parallel or series. For example, a plate press and a filter press may be used in series or parallel to cause the average throughput to reach a desired threshold.

Returning to the plate press example, the relatively concentrated material from the press, for example the “cakes” may be collected from the press and removed. Various embodiments contemplate that the cake material may be augured into a hopper or holding vessel to be removed from the recovery system. Various embodiments contemplate that cake material may be moved to the same container as the material separated in the relatively rough separation stage, for example through the 50 mesh screen. Additionally or alternatively, because of the potential volume of solids produced with the concrete grinding, grooving or sawing process, the ability to unload these stored up solids during the operation, could be essential to continued operating without pause throughout the entire shift. Various embodiments contemplate that the offloading may be facilitated by a self-unloading feature. This unloading aspect would be carried out with the use of augers, conveyor belts, and or vibrators to move these solids from the recovery system trailer to a haul off vehicle.

Various embodiments contemplate that the relatively clean water leaves the relatively finer separation stage to a holding tank. Various embodiment contemplate that the water may be pumped, sucked, driven by gravity, or combinations thereof from the separation device. This holding tank may comprise a relatively small holding tank or a relatively large holding tank. Various embodiments contemplate that the holding tank may comprise a smart tank level technology that may allow a clean water transfer pump to run only at a rate that is required to maintain a constant level in the holding tank, to only cause clean water to flow out of the holding tank when a clean water level threshold is reached, or combinations thereof. Additionally or alternatively, the clean water may then be pumped to a larger holding tank. Various embodiments contemplate that the clean water may be staged and pumped back to the operating device. For example, the clean water may be suitable to be sent to the grinders for use. Various embodiments contemplate that the clean water may have a sufficient amount of the solids removed from the slurry water. Additionally or alternatively, the clean water may have almost all or sufficient amount solids removed and with no additional chemicals or flocculates. Additionally or alternatively, the pH levels of the clean water may be adjusted. For example, the clean water may be pumped into the holding tank and treated to adjust the pH levels. Various embodiments contemplate that the water may be treated to bring the pH to a relatively basic pH, a relatively acidic pH, or a relatively neutral pH. For example, various embodiments contemplate that the water may be set to a pH level that during the operation (for example, grinding) the water may tend towards a more desired pH during the operation, such that any slurry water not recovered would be less damaging to the environment. For example, if an operation, for example grinding often created slurry water with a relatively high pH, clean water directed to the operation may be biased to a lower pH prior to deploying to the operation. Additionally or alternatively, the clean water may be pumped from the holding tank through an automated cabinet. An illustrative embodiment may include but is not limited to a self-contained pH control, neutralization, and monitoring system that may use CO2 gas to neutralize high-pH process water and lower total suspended solids in process water. Additionally or alternatively, the system may user other additives, for example, known acids, bases, and/or buffers to alter the characteristics of the water. For an illustrative example, a Fortrans Model 5000B or similar device. This device would sample the water stream and inject CO2 into the water until the water being circulated met the user defined speciation for pH. This water then can, in general terms then be discharged in pH sensitive areas and it would also meet most turbidity requirements.

Often, it is desirable that the grinders always have a constant pressure and flow to them to keep from damaging the blades. The outflow from the recovery system could be controlled with remote level control (for example, a wireless remote level control) that would maintain a certain level in the water storage tank on the grinders. Additionally or alternatively, this could be turned on and off to fill the tank manually by an operator. Additionally or alternatively, the recovery system may include one or more flow meters. For example, a flow meter may measure and may provide for tracking of the amount of water recovered, reused, or combinations thereof. Additionally or alternatively one or more flow meters may measure the amount of slurry water coming into the recovery system. Additionally or alternatively, a scale may measure the mass of the solids removed from the slurry water. Additionally or alternatively, various embodiments contemplate that one or more of the various sensors may be used to monitor, measure, control, or combinations thereof the throughput of the recovery system.

Additionally or alternatively, various embodiments of the recovery system contemplate configuring the system to provide a balance within the system to provide safety and reliability. For example, the technology used the in the recovery system may leverage features to provide protection to the system and users. For example, automated safeguards, alarms, limits, among others, or combinations thereof may be use to prevent or reduce overflows and mishaps.

While the disclosure focuses on the grinding and grooving applications, this focus is merely illustrative. Other applications are similar in nature but may require their own sizing requirements as well as additional needs such as vacuuming capabilities and pressure washing, and additional technology. For example, drilling, chipping, power washing, cutting, among other applications are contemplated. For example, additional embodiments contemplate that when a water recovery process is utilized in a sawing only application the slurry water that is produced often contains very few larger particles or “chips” of concrete. Therefore the need for the high “G” screen might not be necessary in the system. However, there may be a need to provide a vacuum source to pull up the slurry from the surface and convey it to the recovery system for processing. This vacuum may be provided through a blower utilizing the inlet side of the blower to provide the suction. There a several options for blowers that could be used in this application. There are turbine blowers and rotary type that would work well when sized correctly.

Additionally or alternatively, when this slurry is being sucked up from the vacuum side of the blower it is desirable to prevent it from entering the blower or damage will result. One of the contemplated embodiments may include a properly sized and designed cyclone. The water and air would enter at the top of the cone of the cyclone and will spin around the interior and lose velocity as it moves around and down the cone. At the apex of the vortex the water with the solids will drop out of the air flow to be pumped into the holding tank for the plate press. The remaining air may then vented to atmosphere. Various embodiments contemplate that the air may further be filtered or cleaned prior to final venting. Additionally or alternatively, the saw operation may also need to have the capabilities to pressure wash the concrete after cutting. Combining the pressure washing action along with the vacuuming with the same user and tool would now be possible. This could be done with the pressure washing nozzle combined with the vacuum source to clean up whatever you pressure washed all in one motion.

The volumes of solids in these different applications vary greatly. The overall process of cleaning the water remotely on site remains the same in all cases. The sizes and use of different components may vary to accommodate these variables. While each of the discussed illustrative applications (e.g., Grinding, Grooving, & Sawing) will often require their own unique needs in regards to specific equipment required to operate cost effectively, the disclosed system and methods discussed herein contemplates applying to all.

### Illustrative Systems

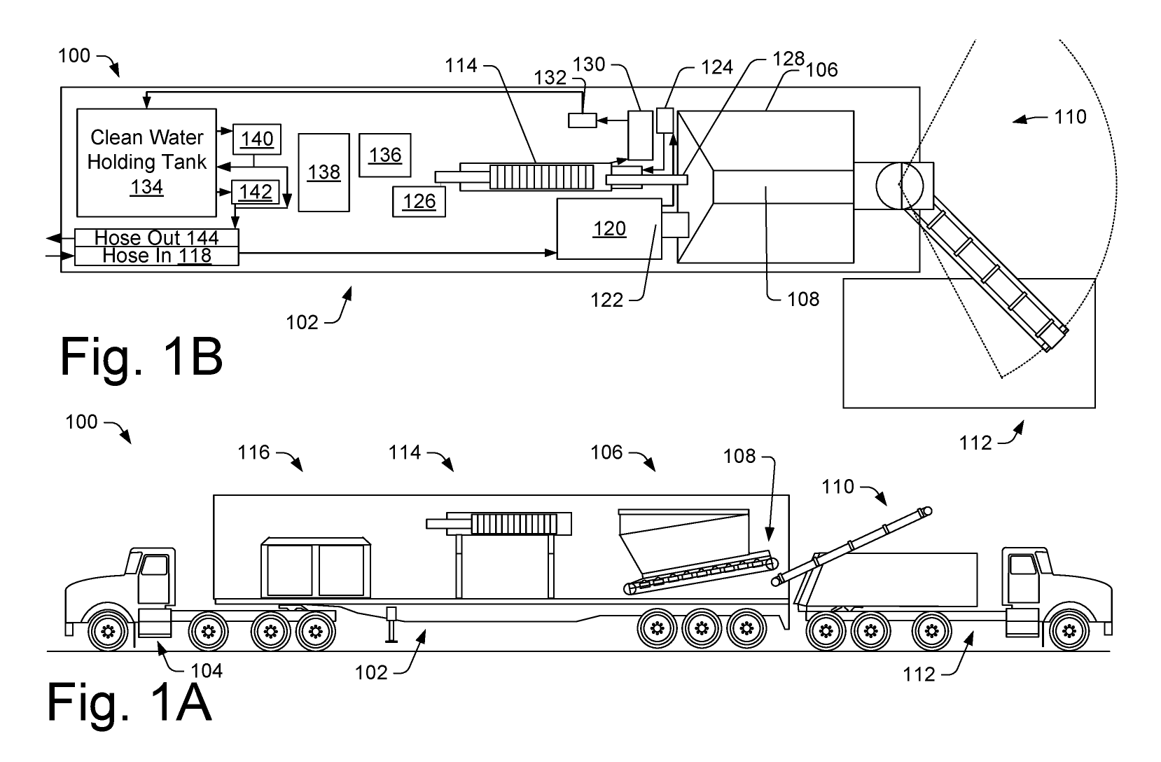

FIGS. 1A-B show an illustrative embodiment of a recovery system 100. For example, FIG. 1A shows a side view cutaway illustrating an illustrative embodiment of a recovery system 100. For example, FIG. 1A shows a recovery platform 102 (e.g., a trailer) coupled to a propulsion system 104 (e.g., a tractor trailer relationship, coupled to a specialized machine (e.g., a grinder, etc), self-propelled, or combinations thereof). FIG. 1A also shows a product storage hopper 106 (e.g., a concrete grind hopper) which may collect various solid materials separated. FIGS. 1A-B also shows various augers and conveyers configured to remove the various solid materials from the recovery system. For example, FIG. 1A shows a conveyers 108 and 110 moving material from the hopper 106. One embodiment contemplates discharging the solid materials to one or more dump trucks 112. FIG. 1A also shows an illustrative plate press 114 as well as a clean water holding tank 116.

FIG. 1B shows a top down view of the illustrative embodiment of the recovery system 100. FIG. 1B shows a slurry water intake 118 located on the trailer 102. While it is shown in the front various embodiments contemplate having the slurry water intake 118 located on the side, top, bottom, rear, of the trailer 102, or combinations thereof. Additionally, FIG. 1B shows a slurry buffer tank 120, a discharge chute 122 to transport the relatively larger particles to the product storage hopper 106. Additionally, FIG. 1B shows a conveyor system (108, 110) that may assist in removing solid material from the recovery system 100. Various embodiments contemplate that the conveyor system may be configured to move relative to the recovery system 100. For example, the conveyor may be configured to raise and lower and move left, right, fore, and aft to accommodate various and multiple off load vehicles including but not limited to dump trucks 112. FIG. 1B shows a press pump 124 that may move slurry water from the slurry buffer tank 120 to the plate press 114. FIG. 1B shows the plate press filter 114 coupled to a hydraulic power unit 126. FIG. 1B shows a discharge auger 128 that may remove solids separated from the plate press filter 114 and may move the solids to the products storage hopper 106. FIG. 1B shows a clean water holding tank 130 that may be used to temporarily store water from the plate press filter 114. The holding tank 130 may be coupled to a clean water pump 132 that may move the clean water to a clean water holding tank 134.

The recovery system may also comprise an air compressor 136, a generator 138, a pH control/treatment system 140, and or a clean water pump 142. FIG. 1B also shows a clean water output 144. Various embodiments contemplate that the clean water output 144 may be located adjacent to or near the slurry water intake 118. Additionally or alternatively, various embodiments contemplate that the clean water output 144 may be located separate from and at various locations slurry water intake 118.

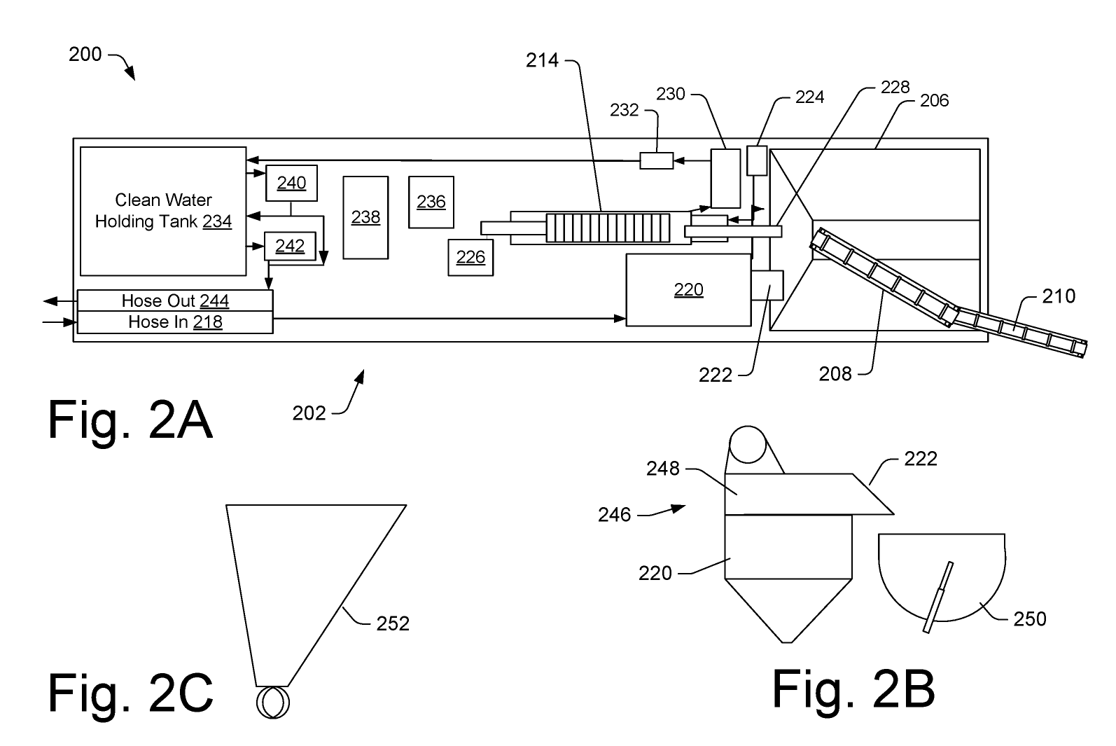

FIGS. 2A-C show an illustrative embodiment of a recovery system 200. For example, FIG. 2A shows a top down view of the illustrative embodiment of the recovery system 200. FIG. 2A shows similar features as those discussed above with respect to FIGS. 1A-B. For example, FIG. 2A shows a top down view of the illustrative embodiment of the recovery system 200. FIG. 2A shows a slurry water intake 218 located on the trailer 202. While it is shown in the front various embodiments contemplate having the slurry water intake 218 located on the side, top, bottom, rear, of the trailer 202, or combinations thereof. Additionally, FIG. 2A shows a slurry buffer tank 220, a discharge chute 222 to transport the relatively larger particles to the product storage hopper 206. Additionally, FIG. 2A shows an auger system (208, 210) that may assist in removing solid material from the recovery system 200. Various embodiments contemplate that the auger system may be configured to move relative to the recovery system 200. For example, the auger may be configured to raise and lower and move left, right, fore, and aft to accommodate various and multiple off load vehicles including but not limited to dump trucks (not shown). FIG. 2A shows a press pump 224 that may move slurry water from the slurry buffer tank 220 to the plate press 214. FIG. 2A shows the plate press filter 214 coupled to a hydraulic power unit 226. FIG. 2A shows a discharge auger 228 that may remove solids separated from the plate press filter 214 and may move the solids to the products storage hopper 206. FIG. 2A shows a clean water holding tank 230 that may be used to temporarily store water from the plate press filter 214. The holding tank 230 may be coupled to a clean water pump 232 that may move the clean water to a clean water holding tank 234.

The recovery system may also comprise an air compressor 236, a generator 238, a pH control/treatment system 240, and or a clean water pump 242. FIG. 2A also shows a clean water output 244. Various embodiments contemplate that the clean water output 244 may be located adjacent to or near the slurry water intake 218. Additionally or alternatively, various embodiments contemplate that the clean water output 244 may be located separate from and at various locations slurry water intake 218.

FIG. 2A shows an illustrative example where the auger and discharge system (208, 210) may be configured to be offset to one side or one corner of the recovery system 200 to provide flexibility and/or efficiency in removing solid products.

FIG. 2B shows an illustrative embodiment of the relatively rough separation stage 246 where for example, the slurry water may enter above a mesh screen system 248 to remove relatively larger particles. The slurry water may pass through the mesh screen system 248 into the slurry buffer tank 220 to be further processed. The relatively larger particles may be collected into a hopper system 250 that may hold or store the particles until they are removed from the system 200. FIG. 2B shows an embodiment where the hopper 250 may be rotated about an axis to remove the particles by dumping them. Additionally or alternatively, FIG. 2C shows a hopper 252 example that may use an auger or conveyor system to remove the particles from the hopper.

### Illustrative Processes

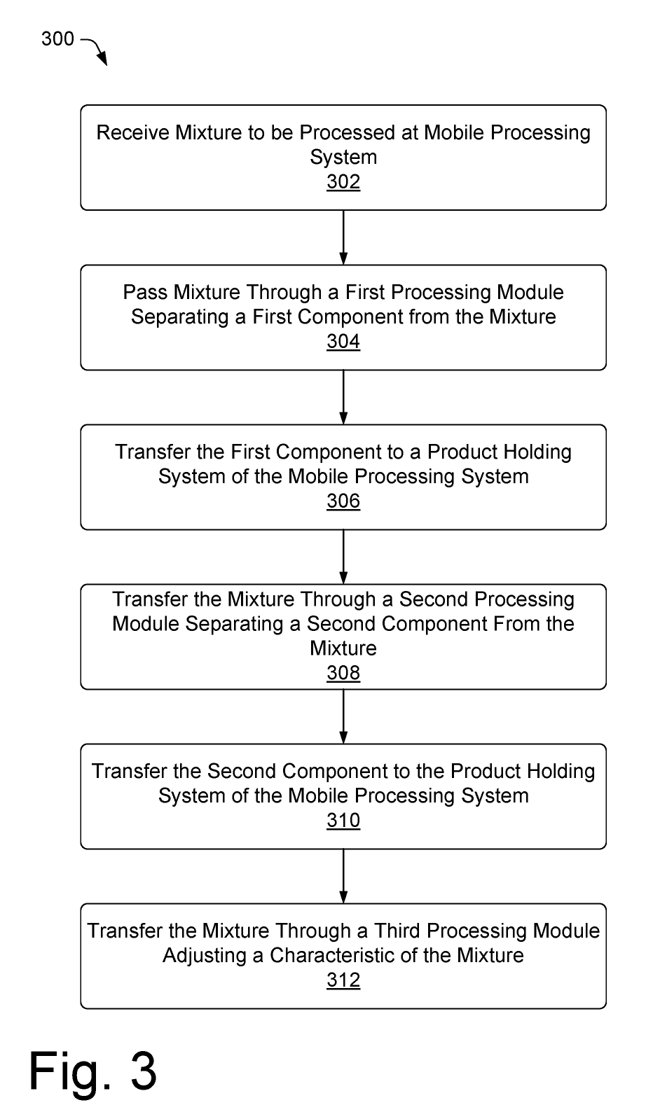

FIG. 3 shows an illustrative process 300 of manipulating a mixture on a mobile processing system. For example, at 302, the mobile processing system may receive a mixture to be processed. Various embodiments contemplate that the mixture comprises several components to be separated. For example, various embodiments contemplate a mixture of water and debris from a construction site, a disaster site, or other locations where remediation is desired. For example, when a roadway is built, resurfaced, or otherwise modified, water is often used in the process to wash away debris including but not limited to rocks, aggregate, dirt, concrete, dust, chemicals, or similar materials. The debris may have various features and/or qualities. For example, the debris may include objects of various sizes (e.g., from micron-level particles to pieces of debris multiple inches across or larger). Often it is desirable to separate the water from the debris.

At 304, the system may pass the mixture through a first processing module to separate a first component from the mixture. For example, the system may transfer the mixture through a screen. For example, the screen may comprise a mesh system of wires or other suitable configuration. Various embodiments contemplate a 50 mesh screen. It is understood that configuring the first processing module is based at least in part on the expected mixture composition as well as a second processing module configuration. Additionally or alternatively, various embodiments contemplate separating the first component based on various characteristics of the component. For example, the separation may be based on size, magnetism, chemical composition, density, or other differentiable characteristics, or combinations thereof.

At 306, the mobile processing system may transfer the first component that is separated to a product holding system. For example, the product holding system may comprise a hopper system.

At 308, the mobile processing system may transfer the mixture after the first component is separated, through a second processing module removing a second component from the mixture. For example, the second processing module may comprise a series of filters that separates the second component from the mixture. Various embodiments contemplate that after passing through the second processing module, the mixture may substantially comprise water with levels of sediment and non-water components at or below a desired level.

At 310, the mobile processing system may transfer the second component after being removed from the mixture to a product holding system. Various embodiments contemplate that the product holding system may be designed based at least in part on the expected characteristics of the second component. Additionally or alternatively, the product holding system may be the same as or similar to the product holding system receiving the first component as discussed above.

At 312, the mobile processing system may transfer the mixture after the first and second components have been removed to a third processing module. Various embodiments contemplate that the third processing module may add, remove, or otherwise adjust a characteristic or a quality of the mixture. For example, the mixture may comprise a substantially clean water solution with a pH level. Various embodiments contemplate that the pH level may be at a level above or below a desired pH level or pH level range. As such, the third processing module may adjust the pH level by adding compounds to bring the pH level to within a desired range. Additionally or alternatively, the ionization of the mixture may be outside of a desired range. As such, the third processing module may adjust the ionization level of the mixture to bring it to within a desired range.

Various embodiments contemplate that the first and second modules may be selected based on compatibility with each other and the debris to be removed. For example, the screen may be selected to be a 50 mesh screen and the filter may be selected to handle material from 0.0117 inches down to the desired minimum particle size. Additionally or alternatively, the mesh size may be selected to be larger than 50 mesh, allowing larger particles through to the filter. In such an embodiment it would be desirable to select the filter to effectively handle the larger particles. Additionally or alternatively, the third processing module may be selected based at least in part on the first and second process module configurations as well as the expected mixture composition and characteristics. For example, if the second process module comprises a filter that is expected to shift the pH of the mixture to be higher, than a desired level, then the third processing module may be configured to bring the pH of the mixture to be at the desired level or within a desired range.

Additionally or alternatively, various embodiments contemplate monitoring various components or subsystems of the modules or mobile processing system, as well as composition and/or characteristics of the mixture at various stages as well as the first and second components. This monitoring may be used to create a feedback control system to control the mobile processing system. For example, a pH sensor may detect a pH level of the mixture in a holding tank. The third processing module may then base its treatment of the mixture on this measurement. Additionally or alternatively, a sensor may detect a size of a particle of the second component after removal from the mixture. For example, if a size of the particle is larger than a threshold (for example, the threshold being based at least on the opening of a mesh component of the first processing module), the system may identify an issue with the first processing module. Additionally or alternatively, based on this identification, the system may alert an operator, may pause a selected operation, may shut down all or a portion of the system or module, may divert a flow to an alternate system, among others, as well as combinations thereof.

Additionally or alternatively, the mobile processing system may hold the processed mixture in a holding system for example, a clean water tank, until it is transfer out of the mobile processing system. For example, various embodiments contemplate that the mixture, after passing through the mobile processing system may be suitable for other uses. For example, the mixture, e.g., clean water, may be used in additional construction activities as discussed above, transferred to a separate holding system, returned to the environment, or combinations thereof.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments. Any portion of one embodiment may be used in combination with any portion of a second embodiment.

What is claimed is:

1. A mobile recovery system comprising:
an intake to receive a medium containing particles;
a separation system comprising stages configured to selectively separate the particles from the medium coupled to the intake, the particles comprising a first component and a second component, the stages comprising:
a first stage, comprising a first processing module to remove the first component from the medium;
a second stage, comprising a second processing module to remove the second component from the medium, a component of the first component being larger than a component of the second component; and
a third stage, comprising a third processing module to adjust a characteristic of the medium;
a particle discharge system coupled to the separation system to remove the separated particles; and
a medium discharge coupled to the separation system to remove the medium from the recovery system after the particles have been separated.

2. The mobile recovery system of claim 1, wherein the medium comprises slurry water from a concrete processing system.

3. The mobile recovery system of claim 1, wherein the separation system comprises a mesh screen system to remove relatively larger particles from the medium and a plate press system to remove relatively finer particles from the medium.

4. A mobile slurry water recovery system comprising:
an intake coupleable to a roadway conditioning device to receive slurry water containing particles;
a separation system comprising one or more stages configured to selectively separate the particles from the medium coupled to the intake;
a particle discharge system coupled to the separation system to remove the separated particles; and
a clean water output coupleable to the roadway conditioning device to deliver clean water to the roadway conditioning device, the clean water comprising the slurry water after separation system has removed the particles from the slurry water.

5. The mobile slurry water recovery system of claim 4, wherein the roadway conditioning device comprises a grinder.

6. The mobile slurry water recovery system of claim 4, wherein the separation system comprises a mesh screen system to remove relatively larger particles from the slurry water and a plate press system to remove relatively finer particles from the slurry water.

7. A method of treating a mixture on a mobile processing system, the steps comprising:
receiving a mixture to be processed by at the mobile processing system;
passing the mixture through a first processing module separating a first component from the mixture;
transferring the first component to a product holding system of the mobile processing system;
transferring the mixture through a second processing module separating a second component from the mixture;
transferring the second component to the product holding system of the mobile processing system; and
transferring the mixture through a third processing module adjusting a characteristic of the mixture.
